(19) United States
(12) Patent Application Publication
(10) Pub. No.: US 2006/0178911 A1
(43) Pub. Date: Aug. 10, 2006

(54) System and user interface for providing patient status and care setting information

(76) Inventors: Iqbal Syed, Orinda, CA (US); Jean Anderson, Phoenixville, PA (US)

Correspondence Address: Siemens Corporation;Intellectual Property Department, 170 Wood Avenue South, Iselin, NJ, 08830, US

(21) Appl. No.: 11/301,922

(22) Filed: Dec. 13, 2005

Related U.S. Application Data
(60) Provisional application No. 60/651,888, filed on Feb. 10, 2005.

(51) Int. Cl. G06F 19/00; G06F 7/00; G06F 3/00

(52) U.S. Cl. 705/3; 707/102; 715/762

(57) ABSTRACT

A system incorporates inpatient and outpatient clinical status information in a display image using layout and graphic symbols to graphically indicate a change in patient care setting and change in a level of care required for the patient. A system for providing patient status and care setting information to a healthcare worker includes a repository incorporating data representing multiple different graphical symbols associated with corresponding different transitions in patient care setting. An acquisition processor acquires data indicating clinical status of a particular patient in a care setting following a transition in care setting. A display processor initiates generation of data representing at least one display image incorporating the data indicating clinical status of the particular patient in the care setting following the transition in care setting and an associated graphical symbol derived from the repository identifying a type of the transition in care setting.

This is a non-provisional application of provisional application Ser. No. 60/651,888 by I. Syed et al. filed Feb. 10, 2005.

### FIELD OF THE INVENTION

This invention concerns a system for providing patient clinical status and care setting information to a healthcare worker concerning transitions in patient care setting.

### BACKGROUND OF THE INVENTION

In Oncology and in other medical areas where a patient is seen over a long period of time, it is necessary for correct diagnostic, treatment and general care to provide a responsible physician with access to comprehensive patient medical information in order to make informed decisions. A patient transition from outpatient to inpatient status, level of care required and care setting generally occurs in response to an event such as a change in patient condition, an emergency, or a related or unrelated problem. Care setting transition and clinical status change information may be valuable to a treating oncologist or other physician. The care setting transition and associated status change information available in existing systems is typically incomplete. Further, in cases where a patient is receiving treatment by multiple imaging (e.g., MRI, CT scan, X-ray, Ultrasound) modalities or therapeutic (e.g., radiation, sonic therapy) modalities or is receiving other treatment, care setting transition and associated clinical status change information is often not available or not readily accessible. A system according to invention principles addresses these deficiencies and associated problems.

### SUMMARY OF THE INVENTION

A system incorporates clinical status information in a display image using layout and graphic symbols to graphically indicate a change in patient care setting, e.g., from inpatient to outpatient and change in a level of care required for the patient during a hospital stay or visit as well as to indicate patient medical history. A system for providing patient status and care setting information to a healthcare worker includes a repository incorporating data representing multiple different graphical symbols associated with corresponding different transitions in patient care setting. An acquisition processor acquires data indicating clinical status of a particular patient in a care setting following a transition in care setting. A display processor initiates generation of data representing at least one display image incorporating the data indicating clinical status of the particular patient in the care setting following the transition in care setting and an associated graphical symbol derived from the repository identifying a type of the transition in care setting.

### BRIEF DESCRIPTION OF THE DRAWING

FIG. 1 shows a networked hospital information system including a user interface system for providing patient status and care setting information, according to invention principles.

FIG. 2 shows a flowchart of patient treatment activities resulting in change in patient status and care setting information, according to invention principles.

FIG. 3 illustrates a graphical symbol set for conveying patient medical data and change in patient status and care setting information, according to invention principles.

FIG. 4 illustrates a patient treatment record employing a graphical symbol set used in an image provided by an oncology care management application, according to invention principles.

FIG. 5 shows a flowchart of a process employed by patient status and care setting information system, according to invention principles.

### DETAILED DESCRIPTION OF THE INVENTION

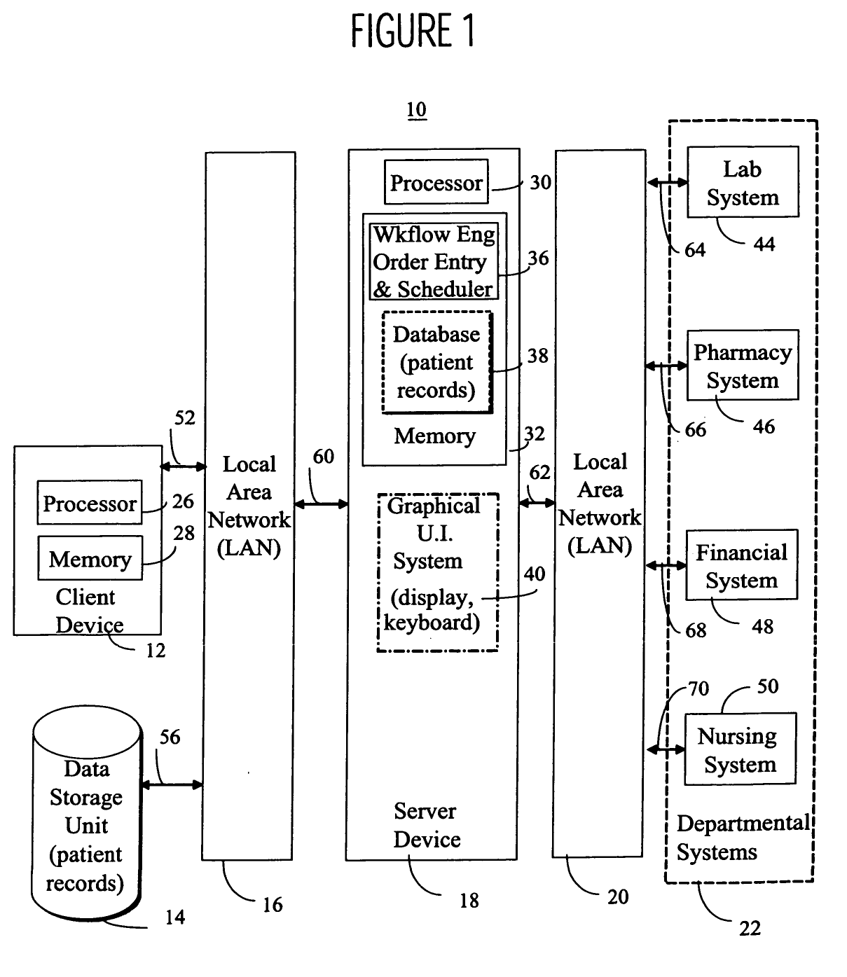

FIG. 1 shows a networked hospital information system 10 including a graphical user interface system for providing patient status and care setting information. The user interface system employs a graphical symbol set and associated software for acquiring and consolidating data to summarize historical treatment information for a single patient. The user interface system uses graphical icons to illustrate patient status and care setting. The inventors have advantageously recognized the graphical symbol set presents information in a format that readily provides pertinent clinical data for an at-a-glance review and facilitates making timely informed decisions. The user interface system incorporates inpatient and outpatient information about a patient in an integrated display with graphic elements showing change in patient status. Layout and graphic symbols convey patient medical history information and graphically indicate change in patient treatment status such as from outpatient to inpatient as well as change within the level of care required for a patient during a hospital stay, for example.

Existing systems fail to provide inpatient-outpatient transition information in a composite single display image that conspicuously indicates to a user, patient care status changes for multiple visits in a user friendly easily understood manner. Existing systems also do not have an integrated data acquisition and display system and typically require multiple searches and multiple screens to provide historical patient data. In contrast, the user interface system graphically details inpatient and outpatient care settings and transitions between the care settings and associated patient data availability and presentation modes. The user interface system provides information to a user at a glance without requiring a user to initiate polling or searching for it. A user is typically unaware of a need to look for the information or a location at which the information may be found. The user interface provides a clear user friendly graphically marked table that shows transitions between inpatient and outpatient care settings and between other care settings such as between a patient room and hospital departments or treatment stations and diagnostic imaging (e.g., MRI, CT scan, X-ray, Ultrasound) or therapeutic (e.g., radiation or sonic) therapy stations. The user interface provides graphical indication of availability of a specific set of laboratory results, diagnostic procedures and results, drugs and procedures of a patient in an associated care setting. The graphical symbol set employed by the user interface may be customized by a user to include symbols associated with transitions of interest for a particular specialty and a type of medical condition (e.g., cancer), for example. The user interface system acquires data from multiple systems or a consolidated data source, or both.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A care setting comprises an inpatient setting or an outpatient setting and includes, for example, a patient room, a room in a particular hospital department, treatment station room such as a diagnostic imaging (e.g., MRI, CT scan, X-ray, Ultrasound) or therapeutic (e.g., radiation or sonic) therapy station or physical therapy room. A transition in care setting comprises a change in status from inpatient to outpatient status or vice versa or a transition between rooms, hospital departments or specialties, associated with care setting.

FIG. 1 shows a hospital information system (HIS) 10 including a user interface 40 providing one or more display images presenting graphic symbols to indicate inpatient and outpatient clinical status information, change in patient care setting, e.g., from inpatient to outpatient and change in a level of care required for the patient during a hospital stay or visit as well as to indicate patient medical history. HIS 10 includes a client device 12, a data storage unit 14, a first local area network (LAN) 16, a server device 18, a second local area network (LAN) 20 and departmental systems 22. Departmental systems 22 are systems that need access to information or provide information related to the health and/or welfare of patients in the care of the healthcare provider. Examples of the departmental systems 22 include, without limitation, a laboratory system 44, a pharmacy system 46, a financial system 48 and a nursing system 50, as shown in FIG. 1, but may also include a records system, a modality (e.g., radiology) system, an accounting system, a billing system, and any other system required or desired in a healthcare information system.

The hospital information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client. The client device 12, e.g., a workstation, includes processor 26 and memory unit 28 and may comprise a personal computer, for example. HIS 10 is used by a healthcare provider that is responsible for providing healthcare services within a hospital or as a separate facility.

Server device 18 includes user interface 40, processor 30, a memory unit 32 including workflow engine, physician order entry and scheduling system 36 and a repository 38 containing patient records including medical data identifying treatments previously received by a patient including graphical symbols. The user interface system 40 input device is a keyboard and mouse, but also may be a touch screen or a microphone with a voice recognition program, or a telephone voice response system for example. The output device, as an alternative (or in addition to) a display, may be a speaker, for example. The output device provides information to the user responsive to the input device receiving information from the user or responsive to other activity by client device 12. For example, a display presents information responsive to the user entering information via a keyboard.

User interface system 40 (which may also reside in client device 12) includes an input device that permits a user to perform data and command entry and input information and an output device that provides a user a display image showing one or more display images presenting graphic symbols to indicate patient clinical status and change in status and care level required. User interface system 40 acquires and integrates clinical and other patient information derived from multiple locations and modality devices (e.g., MRI, CT scan, X-ray, Ultrasound devices) using disparate interfaces to ensure data availability. System 40 displays acquired information together with graphical symbols identifying care setting transitions. System 40 also provides a configuration function enabling a user to define a graphic symbol and incorporate graphic symbols in a user defined display image presenting clinical information provided by a clinical application. The graphic symbol may be configured to focus attention on important information.

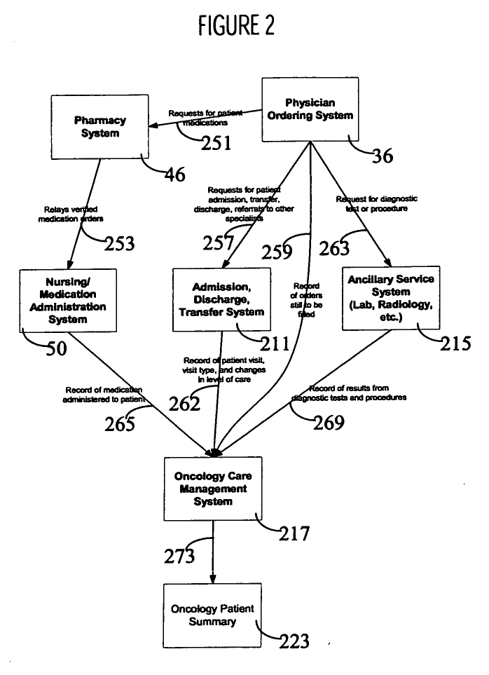

FIG. 2 shows a process flowchart of patient treatment activities resulting in change in patient status and care setting information. In step 251 a user employs an order entry function in unit 36 to initiate placing of an order with pharmacy system 46 for medication to be administered to a patient. In step 257 a user also employs unit 36 to initiate requests for patient admission, discharge, transfer and referrals to specialists with ADT (admission, discharge, transfer) system 211. Similarly, in step 263 a user employs unit 36 to initiate a request for a diagnostic test or procedure via ancillary (e.g., laboratory or radiology) system 215. Further, pharmacy system 46 relays orders that have been validated and filled by a pharmacist to nursing and medication administration system 50 in step 253.

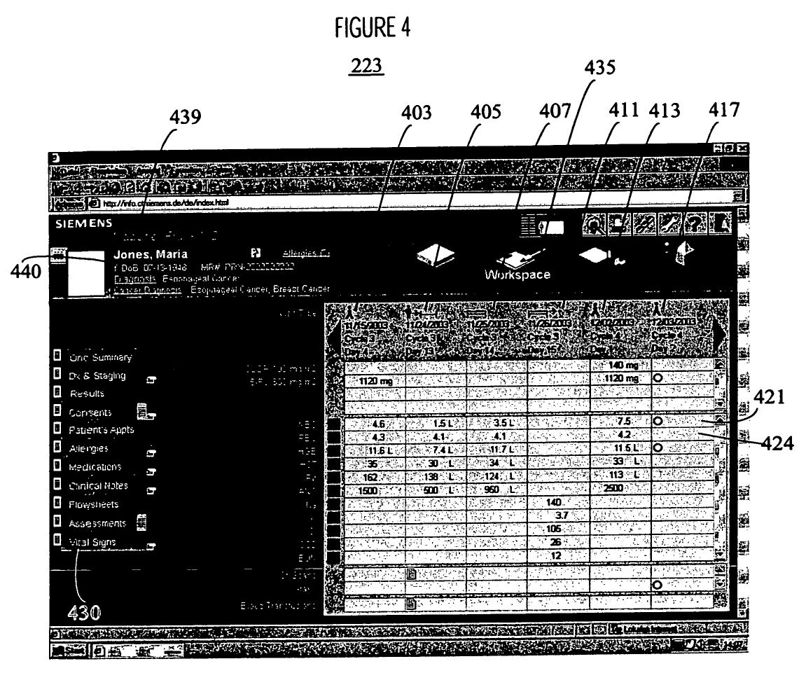

Records of treatment activities are provided by nursing, ADT, ordering and ancillary systems 50, 211, 36 and 215 respectively, to oncology care management system 217, for example. The records are used by user interface system 40 operating in conjunction with oncology care management system 217 to provide a user with display images (exemplified in FIG. 4 discussed later) presenting graphic symbols indicating patient clinical status and change in status and care level required in oncology care management of a patient. Specifically, in steps 265 and 262 respectively, records of medication administered to a patient and of patient visit, visit type, and change in level of care are provided by systems 50 and 211 to oncology care management system 217. Further, in steps 259 and 269 respectively, records of orders remaining to be filled and results from diagnostic tests and procedures are provided by systems 36 and 215 to oncology care management system 217. In step 273, oncology care management system 217 provides records including graphic symbols for inclusion in oncology patient summary record (and display image) 223.

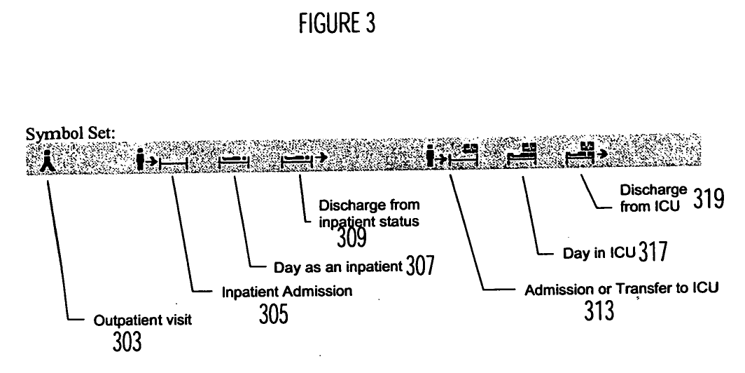

FIG. 3 illustrates a graphical symbol set for conveying patient medical data and change in patient status and care setting information. Symbols 303-319 graphically indicate to a clinician, in a user friendly manner, the patient treatment activities performed in FIG. 2. The graphical symbol set conveys complex information to a user in a manner that is rapidly and easily interpreted and assimilated by the user. The graphical symbols indicate, inpatient and outpatient status and information, change in patient status as well as patient level of care required (e.g., specialist care, intensive continual monitoring, periodic monitoring, on call monitoring etc.). Specifically, the graphical symbols indicate an outpatient visit 303, inpatient admission 305, a day as an inpatient 307, discharge from inpatient status 309, admission and transfer to an Intensive Care Unit (ICU) 313, a day in an ICU 317 and discharge from an ICU 319. The graphical symbols are used to indicate transition in care setting, between care by different hospital departments such as between emergency and radiology departments as well between different types of therapy such as from chemotherapy to radiological therapy. The graphical symbols are presented in a composite display image incorporating additional clinical information of the patient. The additional clinical information may concern a healthcare specialty such as, oncology, cardiology or radiology, for example.

FIG. 4 illustrates a patient treatment record (an Oncology Summary image 223) employing a graphical symbol set used in an image provided by an oncology care management application. The Oncology Summary image shows a workspace 435 (FIG. 4) of a physician 439 comprising oncology care of a particular patient identified in row 440 illustrating usage of the graphic symbols. Selectable labeled buttons in column 430 enable a user to navigate through the functions of the oncology care application. The layout and graphic symbols convey the information about a patient history covering patient data and graphically indicate change in status from outpatient to inpatient and any departmental changes within a hospital or discharge. The oncology summary image presents columns of patient parameters including white blood count (WBC) 421 and red blood count (RBC) 424, for example. Individual columns of data include a graphical symbol 403, 405, 407, 411, 413 and 417. Specifically, symbol 403 indicates an outpatient visit to receive medication on day 4 of a third oncology treatment cycle and symbol 405 indicates a patient care setting transition from outpatient to inpatient (inpatient admission) on day 13 of the third oncology treatment cycle. Symbol 407 indicates a day as an inpatient on day 14 of the third oncology treatment cycle and symbol 411 indicates a patient care setting transition from inpatient to outpatient (discharge from inpatient status) on day 15 of the third oncology treatment cycle. Symbol 413 indicates an outpatient visit on day 1 of the fourth oncology treatment cycle and symbol 417 indicates outpatient visit to receive medication on day 2 of the fourth oncology treatment cycle.

The graphical symbols represent specific events related to changes in patient condition and provide context for clinical data (e.g., in rows 421 and 424) collected and reported during an event or during each day of a multi-day event such as an inpatient stay. System 40 graphically indicates changes in level of care and transitions in care setting together with available patient clinical data in a user friendly image or report presentation. System 40 provides graphical symbols indicating care setting transition in an oncology treatment summary image, in an image used for preparation for clinical activity and in an electronic patient chart or record, for example. The graphical symbols indicate interdepartmental transitions and transitions corresponding to a beginning or end of an inpatient stay and identify whether a patient is admitted directly to an ICU or indirectly via an inpatient stay. The system advantageously quickly and graphically indicates to a physician if a patient had been in an ICU for any portion of an inpatient stay. The graphical symbols also identify transitions from a general inpatient medical or surgery unit to an inpatient oncology unit or other transitions, for example. Although a Patient Record shows inpatient and outpatient visits and specific sets of data related to those visits, the record does not show transitions in level of care.

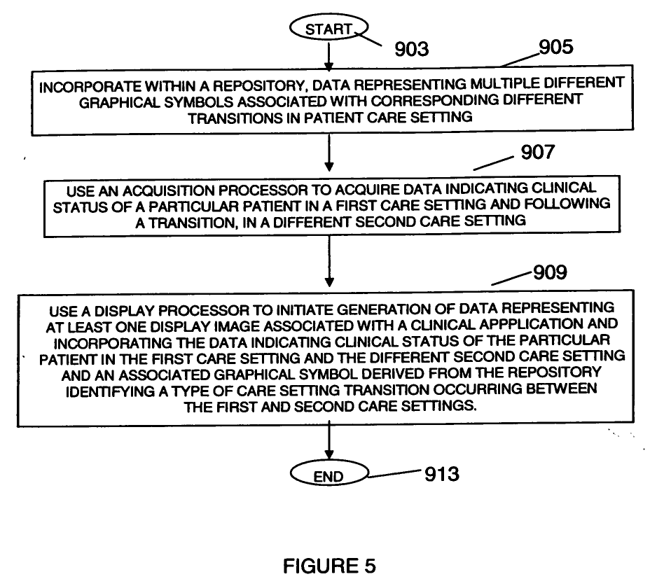

FIG. 5 shows a flowchart of a process employed by user interface system 40 (FIG. 1) operating in conjunction with workflow engine, physician order entry and scheduling system 36 to provide patient status and care setting information. System 40 in step 905, following the start at step 903, incorporates in repository 38, data representing multiple different graphical symbols associated with corresponding different transitions in patient care setting. At least one of the multiple different graphical symbols pictorially indicates a type of care setting transition concerned and comprises at least one of, (a) a graphical character or icon, (b) text and (c) one or more characters.

Repository 38 may comprise multiple repositories that are distributed or localized. The transition in care setting comprises at least one of, an inpatient care setting to an outpatient care setting and an outpatient care setting to an inpatient care setting or a transition from a clinical imaging modality unit to a non-imaging modality unit. The transition in care setting may also comprise at least one of, from a non-intensive care setting to an intensive care setting and from an intensive care setting to a non-intensive care setting as well as a change in hospital inter-departmental care setting. The changed hospital interdepartmental care setting comprises a change between two of, (a) an intensive care unit, (b) a critical care unit, (c) a surgical unit, (d) an examination unit, (e) a physiotherapy unit, (f) an emergency unit, (g) an imaging unit, (h) an obstetrics/gynecology unit, (i) a pediatric unit, (j)a preventive care unit and (k) a radiology unit, for example. The transition in care setting may also comprise a transition from a first healthcare facility to a different second healthcare facility care setting in which the first and second healthcare facilities are owned by different first and second healthcare provider organizations, respectively.

In step 907 an acquisition processor in system 40 acquires data indicating clinical status of a particular patient in a first care setting and following a transition, in a different second care setting. In step 909 a display processor in system 40 initiates generation of data representing at least one display image incorporating the data indicating clinical status of the particular patient in the first care setting and the different second care setting and an associated graphical symbol derived from repository 38 identifying a type of care setting transition occurring between the first and second care settings. The at least one display image may comprise a single display image and the associated graphical symbol indicates the particular patient had been in an intensive care unit for a portion of an inpatient stay, for example. Further, the data indicating clinical status of a particular patient includes at least two of, (a) a blood pressure parameter, (b) a ventilation parameter, (c) a vital sign parameter, (d) a blood oxygen concentration representative parameter, (e) an infusion pump parameter associated with fluid delivery, (f) a drip medication related parameter and (g) another fluid related parameter. In addition, the clinical application comprises at least one of, (a) an oncology application, (b) a patient administration application, (c) a cardiology application, (d) a radiology application and (e) a diagnostic application. The process of FIG. 5 ends at step 913.

Returning to the FIG. 1 system, server device 18 may be implemented as a personal computer or a workstation. Repository (database) 38 provides a location for storing the data representing multiple different graphical symbols associated with corresponding different transitions in patient care setting as well as patient treatment records and other patient records (e.g., financial records). Data storage unit 14 provides an alternate store for patient records, as well as other information in system 10. The information in data storage unit 14, repository 38, unit 36 and system 40 is accessed by multiple users from multiple client devices. Patient records in data storage unit 14 include information related to a patient including, without limitation, biographical, financial, clinical, workflow, care plan and patient encounter (visit) related information.

The first local area network (LAN) 16 (FIG. 1) provides a communication network among the client device 12, the data storage unit 14 and the server device 18. The second local area network (LAN) 20 provides a communication network between the server device 18 and repositories 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the Radiology information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

The system, user interface image and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 1 and process of FIG. 5 may be implemented in hardware, software or a combination of both. The system is applicable to other fields where patient care needs to be coordinated and monitored over an extended period of time such as in care of diabetic patients, for example, or in long term health care facilities, for example.

What is claimed is:

1. A system for providing patient status and care setting information to a healthcare worker, comprising:
a repository incorporating data representing a plurality of different graphical symbols associated with corresponding different transitions in patient care setting;
an acquisition processor for acquiring data indicating clinical status of a particular patient in a care setting following a transition in care setting; and
a display processor for initiating generation of data representing at least one display image incorporating said data indicating clinical status of said particular patient in said care setting following said transition in care setting and an associated graphical symbol derived from said repository identifying a type of said transition in care setting.

2. A system according to claim 1, wherein
said transition in care setting comprises at least one of, (a) an inpatient care setting to an outpatient care setting and (b) an outpatient care setting to an inpatient care setting.

3. A system according to claim 1, wherein
said transition in care setting comprises at least one of, (a) from a non-intensive care setting to an intensive care setting and (b) from an intensive care setting to a non-intensive care setting.

4. A system according to claim 1, wherein
said transition in care setting comprises a change in hospital inter-departmental care setting.

5. A system according to claim 4, wherein
said changed hospital inter-departmental care setting comprises a change between two of, (a) an intensive care unit, (b) a critical care unit, (c) a surgical unit, (d) an examination unit, (e) a physiotherapy unit, (f) an emergency unit, (g) an imaging unit, (h) an obstetrics/gynecology unit, (i) a pediatric unit, (0) a preventive care unit and (k) a radiology unit.

6. A system according to claim 1, wherein
said transition in care setting comprises a transition from a first healthcare facility to a different second healthcare facility care setting.

7. A system according to claim 1, wherein
said first and second healthcare facilities are owned by different first and second healthcare provider organizations, respectively.

8. A system according to claim 1, wherein
said at least one display image comprises a single display image.

9. A system according to claim 1, wherein
said repository comprises a plurality of repositories.

10. A system according to claim 1, wherein
said transition in care setting comprises a transition from a clinical imaging modality unit to a non-imaging modality unit.

11. A system according to claim 1, wherein
said associated graphical symbol indicates said particular patient had been in an intensive care unit for a portion of an inpatient stay.

12. A system according to claim 1, wherein
at least one of said plurality of different graphical symbols comprise at least one of, (a) a graphical character or icon, (b) text and (c) one or more characters.

13. A system according to claim 1, wherein
at least one of said plurality of different graphical symbols pictorially indicates a type of care setting transition concerned.

14. A system according to claim 1, wherein
said data indicating clinical status of a particular patient includes at least two of, (a) a blood pressure parameter, (b) a ventilation parameter, (c) a vital sign parameter, (d) a blood oxygen concentration representative parameter, (e) an infusion pump parameter associated with fluid delivery, (f) a drip medication related parameter and (g) another fluid related parameter.

15. A system for providing patient status and care setting information to a healthcare worker, comprising:
a repository incorporating data representing a plurality of different graphical symbols associated with corresponding different transitions in patient care setting;
an acquisition processor for acquiring data indicating clinical status of a particular patient in a first care setting and following a transition, in a different second care setting; and
a display processor for initiating generation of data representing at least one display image incorporating said data indicating clinical status of said particular patient in said first care setting and said different second care setting and an associated graphical symbol derived from said repository identifying a type of care setting transition occurring between said first and second care settings.

16. A system for providing patient status and care setting information to a healthcare worker, comprising:
a repository incorporating data representing a plurality of different graphical symbols associated with corresponding different transitions in patient care setting;
an acquisition processor for acquiring data indicating clinical status of a particular patient in a care setting following a transition in care setting; and
a display processor for initiating generation of data representing at least one display image associated with a clinical application and incorporating said data indicating clinical status of said particular patient in said care setting following said transition in care setting and an associated graphical symbol derived from said repository identifying a type of said transition in care setting.

17. A system according to claim 16, wherein
said clinical application comprises at least one of, (a) an oncology application, (b) a patient administration application, (c) a cardiology application, (d) a radiology application and (e) a diagnostic application.
